(19) United States
(12) Patent Application Publication
(10) Pub. No.: US 2021/0149280 A1
(43) Pub. Date: May 20, 2021

(54) IMAGE CAPTURING APPARATUS, HANDHELD GIMBAL AND MOVABLE PLATFORM

(71) Applicant: SZ DJI TECHNOLOGY CO., LTD.

(72) Inventors: Wei TUO, Shenzhen (CN); Zhiwei LIU, Shenzhen (CN); Qiang ZHANG, Shenzhen (CN); Zisheng CAO, Shenzhen (CN); Yunyou LU, Shenzhen (CN)

(21) Appl. No.: 17/139,718

(22) Filed: Dec. 31, 2020

Related U.S. Application Data
(63) Continuation of application No. PCT/CN2018/093970, filed on Jul. 2, 2018.

(51) Int. Cl. G03B 17/56; H04N 5/225; F16M 11/12

(52) U.S. Cl. CPC G03B 17/561; F16M 11/12; H04N 5/2251

(57) ABSTRACT

An image capturing apparatus comprises an apparatus body including an adapter; a gimbal including a rotation shaft mechanism detachably connected to the apparatus body, the rotation shaft mechanism including a connection terminal detachably connected to the adapter and electrically connected to the adapter; a sensor imaging device disposed at the rotation shaft mechanism and electrically connected to the connection terminal; and an image processing device disposed at the apparatus body and electrically connected to the sensor imaging device via the connection terminal and the adapter.

### CROSS-REFERENCE TO RELATED APPLICATION

This application is a continuation of International Application No. PCT/CN2018/093970, filed on Jul. 2, 2018, the entire content of which is incorporated herein by reference.

### TECHNICAL FIELD

The present disclosure relates to the technical field of photographing and, more particularly, to an image capturing apparatus, a handheld gimbal, and a movable platform.

### BACKGROUND

For a professional image capturing apparatus, a sensor imaging device and an image processing device, etc. are disposed inside an apparatus body, which makes the apparatus body relatively bulky. When movies and television shows are being filmed, to obtain stable image data, a professional image capturing apparatus is often mounted at a gimbal, and the entire apparatus body needs to be mounted at the gimbal. When a part of the apparatus body or the gimbal needs to be replaced, the entire apparatus body may have to be removed from the gimbal. Due to the bulkiness of the apparatus body, the removing process is complicated. Thus, it not only limits the usability and mobility of the gimbal, but also adds physical burden to a user and makes the use of the image capturing apparatus less flexible.

### SUMMARY

In accordance with the disclosure, there is provided an image capturing apparatus. The image capturing apparatus comprises: an apparatus body including an adapter; a gimbal including a rotation shaft mechanism detachably connected to the apparatus body, the rotation shaft mechanism including a connection terminal detachably connected to the adapter and electrically connected to the adapter; a sensor imaging device disposed at the rotation shaft mechanism and electrically connected to the connection terminal; and an image processing device disposed at the apparatus body and electrically connected to the sensor imaging device via the connection terminal and the adapter.

Also in accordance with the disclosure, there is provided a movable platform. The movable platform comprises an image capturing apparatus including: an apparatus body including an adapter; a gimbal including a rotation shaft mechanism detachably connected to the apparatus body, the rotation shaft mechanism including a connection terminal detachably connected to the adapter and electrically connected to the adapter; a sensor imaging device disposed at the rotation shaft mechanism and electrically connected to the connection terminal; and an image processing device disposed at the apparatus body and electrically connected to the sensor imaging device; and a driving assembly connected to the image capturing apparatus and configured to drive the image capturing apparatus to move.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of an image capturing apparatus according to an example embodiment of the present disclosure.

FIG. 2 is a schematic structural diagram of an image capturing apparatus according to another example embodiment of the present disclosure.

FIG. 3 is a schematic structural diagram of an image capturing apparatus according to another example embodiment of the present disclosure.

FIG. 4 is a schematic structural diagram of an image capturing apparatus according to another example embodiment of the present disclosure.

FIG. 5 is a schematic structural diagram of an image capturing apparatus according to another example embodiment of the present disclosure.

FIG. 6 is a schematic structural diagram of an image capturing apparatus according to another example embodiment of the present disclosure.

FIG. 7 is a schematic structural diagram of an image capturing apparatus according to another example embodiment of the present disclosure.

FIG. 8 is a schematic structural diagram of an image capturing apparatus according to another example embodiment of the present disclosure.

FIG. 9 is a schematic structural diagram of an image capturing apparatus according to another example embodiment of the present disclosure.

FIG. 10 is a schematic structural diagram of an image capturing apparatus according to another example embodiment of the present disclosure.

FIG. 11 is a schematic structural diagram of an image capturing apparatus according to another example embodiment of the present disclosure.

FIG. 12 is a schematic structural diagram of an image capturing apparatus according to another example embodiment of the present disclosure.

FIG. 13 is a schematic structural diagram of an image capturing apparatus according to another example embodiment of the present disclosure.

FIG. 14 is a schematic structural diagram of an image capturing apparatus according to another example embodiment of the present disclosure.

FIG. 15 is a schematic structural diagram of an image capturing apparatus according to another example embodiment of the present disclosure.

FIG. 16 is a schematic structural diagram of an image capturing apparatus according to another example embodiment of the present disclosure.

FIG. 17 is a schematic structural diagram of a handheld gimbal according to an example embodiment of the present disclosure.

FIG. 18 is a schematic structural diagram of a movable platform according to an example embodiment of the present disclosure.

### REFERENCE NUMERALS IN THE DRAWINGS

100: handheld member
200: image capturing apparatus
1: apparatus body
11: first adapter
12: image output interface
13: control interface
14: storage interface
2: gimbal
21: rotation shaft mechanism
211: first connection terminal
212: second connection terminal
22: control circuit
23: inertial measurement unit (IMU)
3: sensor imaging device
31: lens
32: image sensor
33: enclosure
34: filter
4: image processing device
41: image processor
42: second adapter
43: third adapter
5: first signal line
6: encoder
61: fourth adapter
7: storage device
71: memory card
72: card reader
8: second signal line
9: heat sink
10: controller
300: driving assembly
400: body

### DETAILED DESCRIPTION OF THE EMBODIMENTS

Embodiments of the present disclosure are described in detail below with reference to the accompanying drawings. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

An image capturing apparatus, a handheld gimbal for the image capturing apparatus, and a movable platform consistent with the embodiments of the present disclosure will be described in detail below with reference to the accompanying drawings. In the case of no conflict, the following embodiments and features in the implementation can be combined with each other.

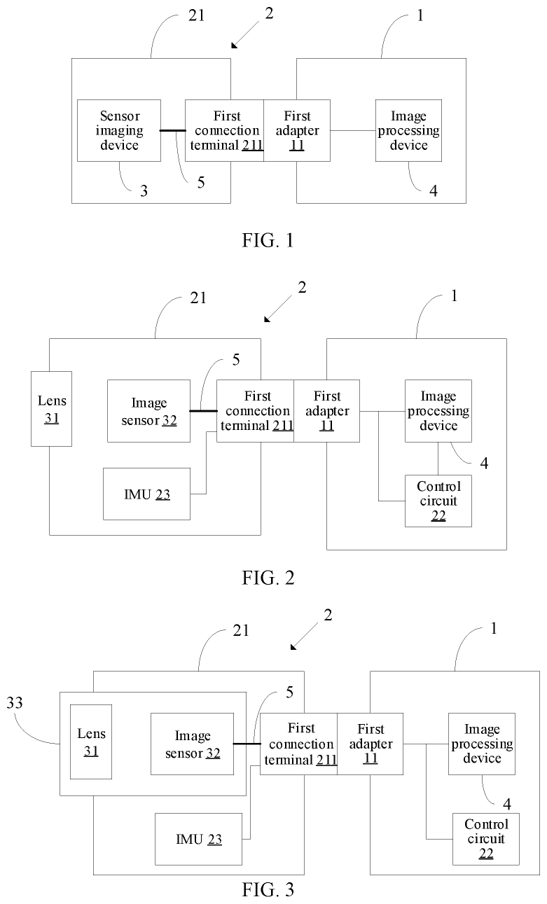

FIG. 1 is a schematic structural diagram of an image capturing apparatus according to an example embodiment of the present disclosure. As shown in FIG. 1, the image capturing apparatus includes an apparatus body 1, a gimbal 2, a sensor imaging device 3, and an image processing device 4. The apparatus body 1 includes a first adapter 11. The gimbal 2 includes a rotation shaft mechanism 21 with a first connection terminal 211. The sensor imaging device 3 is disposed at the rotation shaft mechanism 21, and is electrically connected to the first connection terminal 211. The image processing device 4 is disposed at the apparatus body 1. In some embodiments, the image processing device 4 is disposed inside the apparatus body 1 or on the apparatus body 1. In some embodiments, the first connection terminal 211 is detachably connected to the first adapter 11, such that the rotation shaft mechanism 21 is detachably connected to the apparatus body 1. Moreover, the first connection terminal 211 is electrically connected to the first adapter 11, such that the sensor imaging device 3 is electrically connected to the image processing device 4.

In some embodiments, the sensor imaging device 3 that needs to be stabilized is disposed at the rotation shaft mechanism 21 of the gimbal 2 while other parts that do not need to be stabilized are disposed at the apparatus body 1, thereby substantially reducing the volume and weight of a load on the rotation shaft mechanism 21. Moreover, the rotation shaft mechanism 21 and the apparatus body 1 are detachably mechanically connected and detachably electrically connected through the detachable connection between the first connection terminal 211 and the first adapter 11. When the sensor imaging device 3 or the rotation shaft mechanism 21 needs to be replaced, only the rotation shaft mechanism 21 needs to be detached from the apparatus body 1. It is convenient and quick to detach. Thus, the usability and mobility of the gimbal 2 are improved, the physical burden to the user is reduced, and the flexibility is achieved. In addition, coupling of the first connection terminal and the first adapter achieves the multiplexing of a mechanical connection interface, an electrical connection interface, and other structures such as the image processing device, thereby reducing economic cost, simplifying product structure, and improving product aesthetic appearance.

In some embodiments, the rotation shaft mechanism 21 rotates to drive the sensor imaging device 3 to rotate to a desired photographing angle. Specifically, the rotation shaft 21 includes a bracket and an electric motor for driving the bracket. The first connection terminal 211 and the sensor imaging device 3 are disposed at the bracket. In some embodiments, the gimbal is a three-axis gimbal. The electric motor includes a yaw-axis electric motor, a pitch-axis electric motor, and a roll-axis electric motor. In some other embodiments, the gimbal 2 may be a single-axis gimbal or a two-axis gimbal.

Further, referring to FIG. 2 through FIG. 4, the gimbal 2 further includes a control circuit 22 for controlling the operation of the rotation shaft mechanism 21. In some embodiments, the control circuit 22 is disposed at the apparatus body 1. For example, the control circuit 22 may be disposed inside the apparatus body 1 or may be disposed at the apparatus body 1. Disposing the control circuit 22 at the apparatus body 1 further reduces the weight of the load on the rotation shaft mechanism 21 and facilitate the user to replace the rotation shaft mechanism 21. In another embodiment, the control circuit 22 is disposed at the rotation shaft mechanism 21. For example, the control circuit 22 may be disposed at the bracket or inside the bracket, or may be disposed at a rotor enclosure of the electric motor.

In addition, the control circuit 22 consistent with embodiments of the present disclosure may be electrically connected to the image processing device 4. The user may communicate with the image processing device 4 through an external control device. A gimbal control command sent by the external control device may be inputted to the control circuit 22 through the image processing device 4. According to the gimbal control command, the control circuit 22 controls the rotation of the electric motor in the rotation shaft mechanism 21. The electric motor drives the bracket in the rotation shaft mechanism 21 to rotate, and hence drives the sensor imaging device 3 to rotate to the desired photographing angle. When the control circuit 22 is disposed inside the apparatus body 1, the control circuit 22 is electrically connected to the first adapter 11. Through the electrical coupling of the first adapter 11 and the first connection terminal 211, the electrical connection between the control circuit 22 and the electric motor is achieved.

In some embodiments, the control circuit 22 is electrically connected to the external control device directly while an indirect electrical connection between the control circuit 22 and the external control device through the electrical coupling of the control circuit 22 and the image processing device 4 described in the above embodiments is not needed. In some embodiments, the gimbal control command sent by the external control device is directly sent to the control circuit 22. According to the gimbal control command, the control circuit 22 controls the electric motor in the rotation shaft mechanism 21 to rotate.

Referring to FIG. 2 through FIG. 4, the gimbal 2 further includes an inertial measurement unit (IMU) 23. The IMU 23 is disposed at the rotation shaft mechanism 21 and is electrically connected to the control circuit 22. The IMU 23 includes a gyroscope and an accelerometer. The control circuit 22 obtains an angular velocity of the rotation shaft mechanism 21 through the gyroscope, obtains an acceleration of the rotation shaft mechanism 21 through the accelerometer, and determines current attitude information of the rotation shaft mechanism 21 based on the angular velocity and the acceleration. The control circuit 22 adjusts the current attitude information of the rotation shaft mechanism 21 correspondingly based on target attitude information.

The IMU 23 and the control circuit 22 are communicatively connected in various manners. For example, in some embodiments, referring to FIG. 2 through FIG. 4, the control circuit 22 is disposed inside the apparatus body 1. The IMU 23 is electrically connected to the first connection terminal 211. The control circuit 22 is electrically connected to the first adapter 11. The angular velocity and the acceleration detected by the IMU 23 is sent to the control circuit 22 through the first connection terminal 211 and the first adapter 11. In other embodiments, the control circuit 22 is disposed inside the apparatus body 1. The IMU 23 and the control circuit 22 are electrically connected through wires. In another embodiment, the control circuit 22 is disposed at the rotation shaft mechanism 21, and the IMU 23 and the control circuit 22 are directly connected through the wires.

The sensor imaging device 3 obtains the image data. Referring to FIG. 2 and FIG. 3, the sensor imaging device 3 includes a lens 31 and an image sensor 32 coupled with the lens 31. Both the lens 31 and the image sensor 32 are mounted at the rotation shaft mechanism 21. Specifically, in some embodiments, the lens 31 and/or the image sensor 32 are detachably connected to the rotation shaft mechanism 21. In some embodiments, the lens 31 and the image sensor 32 are detachably connected to the rotation shaft mechanism 21, respectively. The lens 31 and the image sensor 32 may be separately replaced. In some embodiments, the rotation shaft mechanism 21 includes a bracket. The bracket includes a bayonet. The lens 31 is inserted into the bayonet. When the lens 31 needs to be replaced with a lens with a different specification, the lens 31 is disassembled from the bayonet. So the lens 31 can be quickly replaced. Further, the bracket includes an accommodation space. The image sensor 32 may be accommodated in the accommodation space to prevent external ambient light from interfering the image sensor 32.

In another embodiment, referring to FIG. 3, the sensor imaging device 3 includes an enclosure 33. Both the lens 31 and the image sensor 32 are fixed to the enclosure 33. The enclosure 33 is detachably connected to the rotation shaft mechanism 21. In some embodiments, the enclosure 33, the lens 31, and the image sensor 32 form an integral structure. When the lens 31 and the image sensor 32 need to be replaced with ones with different specifications, the enclosure 33 may be directly disassembled from the rotation shaft mechanism 21, and another enclosure 33 including the lens 31 and the image sensor 32 may be mounted to the rotation shaft mechanism 21. Thus, the lens 31 and the image sensor 32 can be replaced at the same time, thereby expediting the replacement of both the lens 31 and the image sensor 32. Moreover, after a sensor assembly including the lens 31, the image sensor 32, and the enclosure 33 is replaced, no adjustment of a relative position between the lens 31 and the image sensor 32 is required, which is more convenient to use. The enclosure 33 and the rotation shaft mechanism 21 may be detachably connected in any existing detachable connection manner, which is not specifically limited by the present disclosure.

The type of the image sensor 32 is selected as needed. For example, the image sensor 32 may be a complementary metal oxide semiconductor (CMOS) type, a charge-coupled device (CCD) type, or another suitable type of image sensor.

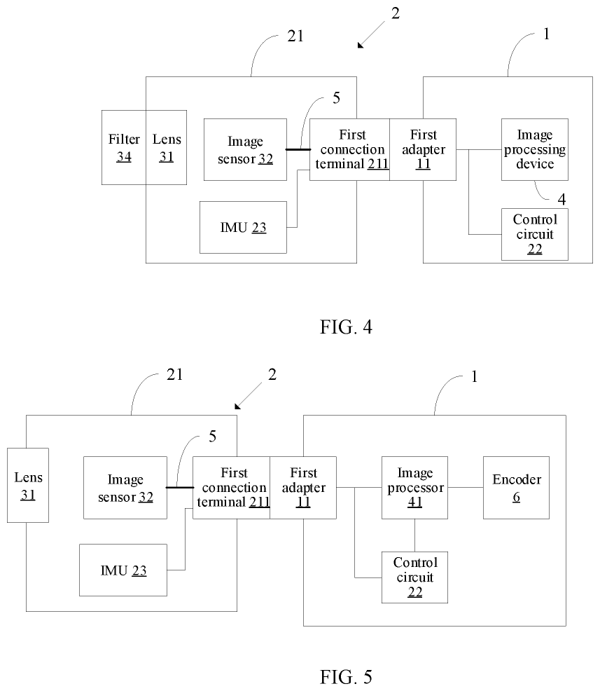

Referring to FIG. 4, the sensor imaging device 3 further includes a filter 34 disposed at a side of the lens 31 away from the image sensor 32. The filter 34 filters out unwanted ambient light for the need of imaging.

In addition, referring to FIG. 1 through FIG. 4, the image capturing apparatus further includes a first signal line 5, through which the sensor imaging device 3 and the first connection terminal are electrically connected. The transmission data rate of the first signal line 5 is greater than a first specified data rate to satisfy the need for transmitting the image data of a corresponding size. In some embodiments, the first signal line 5 is a flexible high-speed signal line for transmitting high-definition image data.

Referring to FIG. 5, the image processing device 4 consistent with embodiments of the present disclosure includes an image processor 41. The first adapter 11 and the image processor 41 are electrically connected. In some embodiments, the image processor 41 is used to process the image data obtained by the sensor imaging device 3 to generate images and/or videos. Specifically, the image data obtained by the sensor imaging device 3 may be transmitted to the image processor 41 through the first connection terminal 211 and the first adapter 11. The image processor 41 processes the image data to generate the images and/or the videos.

In some embodiments embodiment, the image data obtained by the sensor imaging device 3 is in a RAW format, and processing the image data by the image processor 41 includes the following.

(1) The received image data is adapted or pre-processed to correct any loss and errors occurred during image data transmission, such that the image data meets certain electrical and timing requirements.

(2) Processing such as white balance, mosaic removal, color correction, Gamma, RGB to YUV conversion, noise reduction, or image sharpening is performed to the image data in the RAW format to generate the image data in the YUV format compliant to video data standards such as ITU-R BT.709.

In some embodiments, the format of the images and/or videos generated by the image processor 41 includes at least one of RAW, RGB, or YUV. In some embodiments, the format of the images and/or videos generated by the image processor 41 includes other formats. The format is determined as needed. RAW format is commonly used in professional photography. In some embodiments, the format of the images and/or videos generated by the image processor 41 is RAW.

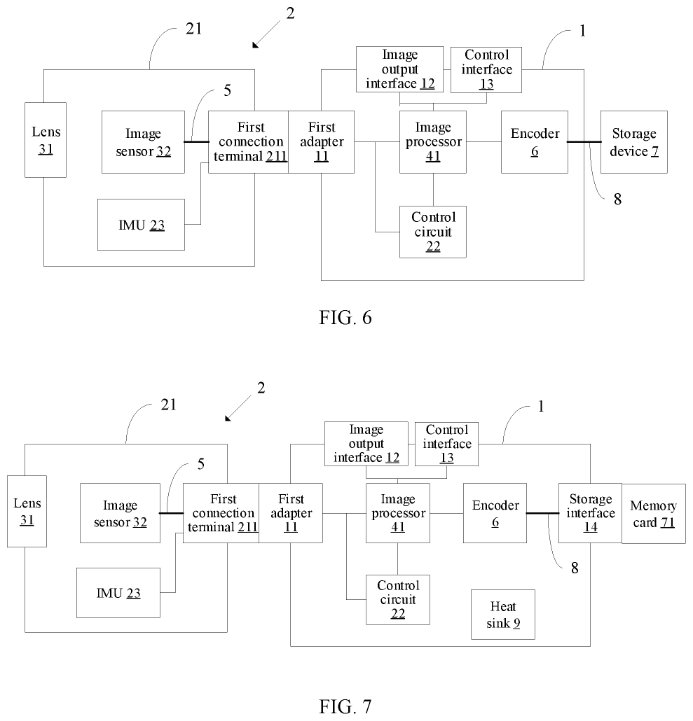

Further, in some embodiments, referring to FIG. 6, the apparatus body 1 also includes an image output interface 12. The image output interface is electrically connected to the image processor 41. The images and/or videos generated by the image processor 41 may be transmitted through the image output interface 12 to a backend device (e.g., a device for displaying the images/videos photographed or filmed by the image capturing apparatus) for monitoring. The image output interface 12 includes a wireless interface and/or a wired interface, for example, an SDI wired interface. When the image capturing apparatus is used in aerial photography, the backend device may include a display device operated by a photographer, an unmanned aerial vehicle (UAV) operator, or a gimbal operator.

Further, referring to FIG. 6, the apparatus body 1 also includes a control interface 13. The control interface 13 is electrically connected to the image processor 41 for connecting to the external control device, such that the external control device and the image processor 41 are communicatively connected. In some embodiments, the external control device controls the operation of the image capturing apparatus through the control interface 13. For example, the external control device may send an image capture command to the image processor 41 through the control interface 13. According to the received image capture command, the image processor 41 control the sensor imaging device 3 to capture images. Further, the external control device also sends the gimbal control command to the image processor 41 through the control interface 13. The image processor 41 relays the gimbal control command to the control circuit 22 of the gimbal 2. According to the gimbal control command, the control circuit 22 controls the rotation of the electric motor in the rotation shaft mechanism 21. It should be understood that the operation of controlling the image capturing apparatus by the external control device through the control interface 13 is not limited to the above described embodiments.

In some embodiments, the external control device is a remote controller or a terminal device (e.g., a mobile phone, a tablet computer) with an APP installed.

In addition, referring to FIG. 5 through FIG. 7, the image capturing apparatus further includes an encoder 6 electrically connected to the image processor 41. The encoder 6 is disposed at the apparatus body 1. Specifically, the encoder 6 may be disposed inside the apparatus body 1 or on the apparatus body 1. In some embodiments, the encoder 6 is used to perform compression processing to the images and/or videos generated by the image processor 41 for subsequent storage.

In some embodiments, the format of the images and/or videos generated by the image processor 41 that can be processed by the encoder 6 includes at least one of RAW, Apple ProRes RAW, DNxHR/DNxHD, or JPEG-Lossless. JPEG-Lossless is a coding format for images. The format of the images and/or videos generated by the image processor 41 that can be processed by the encoder 6 may not be limited to the above described formats, and may include another suitable format.

Further, the encoder 6 may also use various file formats such as CinemaDNG and Quicktime to encapsulate the images and/or videos in the above described coding formats.

Referring to FIG. 6, the image capturing apparatus consistent with the embodiments of the present disclosure further includes a storage device 7. In some embodiments, the storage device 7 is electrically connected to the encoder 6. The storage device 7 is used to store the images and/or videos compressed by the encoder 6. For example, the user needs to store the image data in the RAW format. Because the image data generated by the image processor 41 in the RAW format is often substantially large, the image data may have to be compressed before being transmitted to and stored in the storage device 7. In another embodiment, the storage device 7 is electrically connected to the image processor 41. The storage device 7 is used to store the images and/or videos compressed by the encoder 6. For example, the user needs to store image data in the YUV format. The images and/or videos generated by the image processor 41 in the YUV format is directly transmitted to and stored in the storage device 7. In another embodiment, the storage device 7 is electrically connected to both the encoder 6 and the image processor 41. The storage device 7 is used to store the images and/or videos generated by the image processor 41, and/or the images and/or videos compressed by the encoder 6.

In some embodiments, the storage device 7 is disposed at the apparatus body 1. In some other embodiments, the storage device is disposed outside the apparatus body 1. For illustration purpose, in the following embodiments, the storage device 7 is disposed at the apparatus body 1.

In addition, referring to FIG. 6 through FIG. 8, the image capturing apparatus consistent with the embodiments of the present disclosure further includes a second signal line 8, through which the storage device 7 is electrically connected to the encoder 6 and/or the image processor 41. The transmission data rate of the second signal line 8 is greater than a second specified data rate to satisfy the need for transmitting the image data of the corresponding size. In some embodiments, the second signal line 8 is a flexible high-speed signal line for transmitting high-definition image data.

Further, referring to FIG. 7, the apparatus body 1 includes a storage interface 14. The encoder 6 and/or the image processor 41 are electrically connected to the storage interface 14 through the second signal line 8. The storage device 7 is electrically connected to the storage interface 14.

The type of the storage interface 14 and the type of the storage device 7 is selected as needed. For example, the storage interface 14 may be a solid-state disk (SSD) interface, and the storage device may be a solid-state disk (SSD).

In some embodiments, the storage interface 14 is a memory card interface, and the storage device 7 may be a memory card 71. For example, the storage interface 14 is an SD card interface, and the storage device 7 is an SD card.

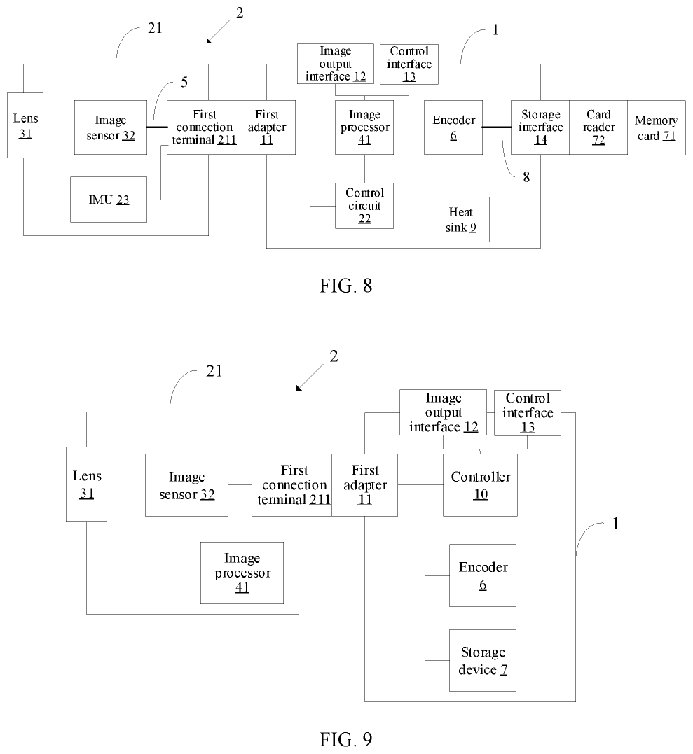

In some embodiments, the storage interface 14 is a communication interface such as a USB interface. Referring to FIG. 8, the storage device 7 includes a card reader 72 and the memory card 71 coupled with the card reader 72. The card reader 72 is electrically connected to the storage interface 14. In some embodiments, the memory card 71 is an SD card.

In addition, referring to FIG. 7, the image capturing apparatus consistent with the embodiments of the present disclosure also includes a heat sink 9 disposed inside the apparatus body 1. The heat sink 9 is used to dissipate heat from the image processing device 4 disposed inside the apparatus body 1. The heat sink 9 may include a heat dissipation fan or a heat conduction structure.

The image capturing apparatus consistent with the embodiments of the present disclosure may be used for filming professional movies and television shows, etc. Specifically, in some embodiments, a diagonal line of an effective imaging area of the image sensor 32 is greater than or equal to about 25.8 mm. In professional filming and photography, the resolution for the image data obtained by the image capturing apparatus needs to be substantially high. The 25.8 mm or more diagonal line enables the image sensor 32 to obtain the high-resolution image data to satisfy the user's visual requirement and improve the user's viewing experience. The effective imaging area may be in a shape of a rectangle or a square.

Further, the resolution of the image sensor 32 is no smaller than 4K (i.e., 4096×2160 pixels). In professional filming and photography, the resolution for the image data obtained by the image capturing apparatus needs to be substantially high. The image sensor 32 consistent with the embodiments of the present disclosure has the resolution no smaller than 4K, such as 4K, 5K, 6K, 7K, 8K, 9K, 10K, 12K, etc. to satisfy the requirement for the professional filming and photography, obtain the high-resolution image data, and improve the user's viewing experience.

Further, when in operation, professional image capturing apparatuses or cameras for filming movies and television shows are often mounted at dollies, cranes, and other movable platforms that can move smoothly with a certain degree of freedom, but are more and more popular handheld. The handheld image capturing apparatuses or cameras can move quickly between different scenes, such as stairs, street alleys, windows, etc. while filming action scenes involving complicated movements and hard to arrange tracks in advance. The professional image capturing apparatuses or cameras often include built-in high-speed encoding and storage devices for RAW/ProRes/DNxHR recording, and various functional units/circuits/devices supporting optical image sensing, view finding, power supply, heat dissipation, and image processing to meet the image quality requirements for filming movies and television shows. As such, the dimension of the apparatus body of the professional image capturing apparatus is substantially large. Further, more and more image capturing apparatuses support 6K/8K image resolutions, which substantially increase the amount of recorded data as compared with previous 2K image resolution, and further raises the requirements for the processing and recording capability of the image capturing apparatuses. The dimension, the weight and rotation momentum, and the volume of the apparatus body of the professional image capturing apparatus are often relatively large. As a result, a stabilizer has relatively large dimension and power consumption, and is difficult to minimize.

Using the stabilizer (e.g., the gimbal) to stabilize the professional image capturing apparatus limits the possibility of minimizing the professional image capturing apparatus with the stabilization function, and at the same time substantially increases the cost required for using the professional image capturing apparatus with the stabilization function to perform aerial filming and photographing or ground level filming and photographing. As a result, the usability and mobility of the stabilizer operated in a small space are limited, and the physical burden on the photographer or camera man increases.

In the embodiments of the present disclosure, through separating the function modules for image processing, encoding, and recording, etc. and the function module for optical imaging sensing in the image capturing apparatus, the dimension of the apparatus body of the image capturing apparatus are substantially reduced, the dimension and weight of the load to the gimbal are reduced, the flexibility and portability of the gimbal are increased, and the maneuverability and the adaptability of the image capturing apparatus for the ground level and aerial scenes are improved.

In addition, the present disclosure is compatible with the imaging system configuration with replaceable gimbal, improves the interchangeability of devices, and helps reduce the total weight and the total cost of the devices carried by the user when the user can replace sensors/optical systems as needed.

In the above described embodiments, the sensor imaging device 3 is disposed at the rotation shaft mechanism 21, and the image processor 41, the encoder 6, and the storage device 7 are disposed at the apparatus body 1. More embodiments with different configurations are described below.

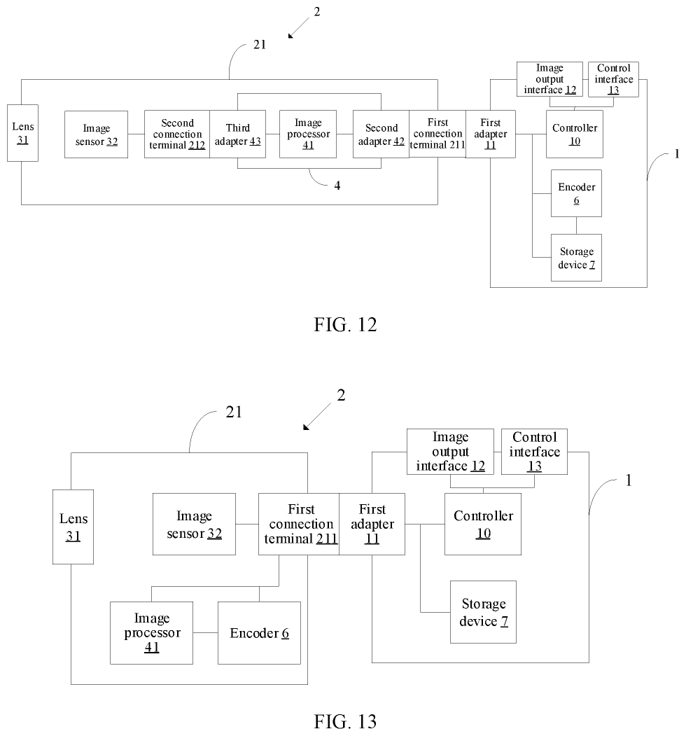

In some embodiments, referring to FIG. 9 and FIG. 12, the sensor imaging device 3 and the image processor 41 are disposed at the rotation shaft mechanism 221, and the encoder 6 and the storage device 7 are disposed at the apparatus body 1. Compared to the existing technology where the sensor imaging device 3, the image processor 41, the encoder 6, and the storage device 7 are disposed at the apparatus body, and the apparatus body 1 is driven by the gimbal 2 to rotate, in the embodiments of the present disclosure, only the sensor imaging device 3 and the image processor 41 are disposed at the rotation shaft mechanism 21 of the gimbal 2 while the encoder 6 and the storage device 7 are disposed at the apparatus body 1, thereby reducing the volume and weight of the load to the rotation shaft mechanism 21. Moreover, the encoder 6, the storage device 7, and other structures disposed at the apparatus body 1 are multiplexed to reduce the economic cost, simplify the product structure, and improve the product aesthetic appearance.

In some embodiments, the image processing device 4 is electrically connected to the first connection terminal 211, and the encoder 6 is electrically connected to the first adapter 11. Moreover, the first connection terminal 211 is electrically connected to the first adapter 11, such that the electrical connection between the sensor imaging device 3 and the image processing device 4 is replaced by the electrical connection between the first connection terminal 211 and the first adapter 11. As a result, the image processing device 4 is electrically connected to the encoder 6.

The image processor 41 may be disposed inside the rotation shaft mechanism 21 or may be disposed at the rotation shaft mechanism 21, which is selected as needed.

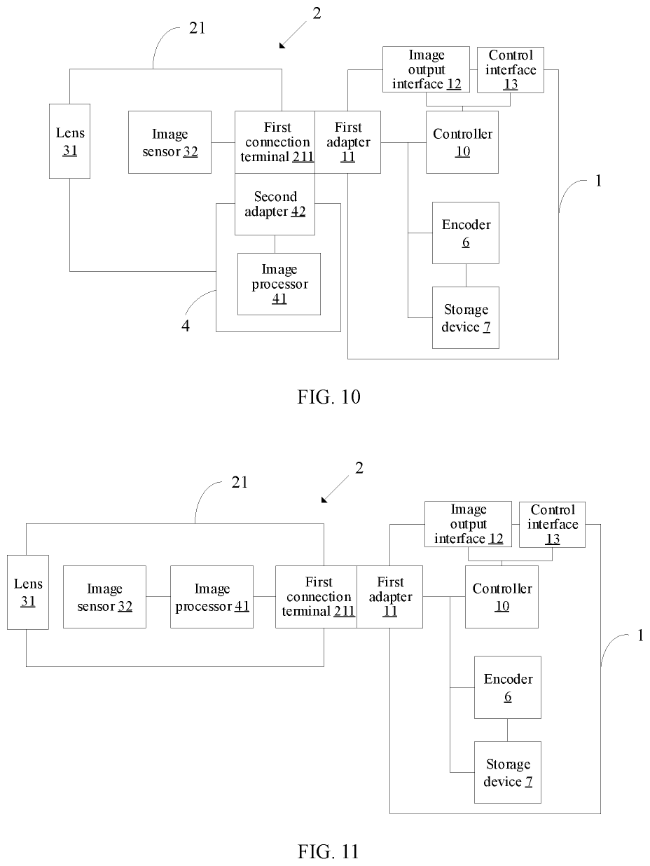

In some embodiments, the sensor imaging device 3 and the first connection terminal 211 may be electrically connected directly or indirectly. For example, in some embodiments, the sensor imaging device 3 and the first connection terminal 211 is electrically connected directly. The sensor imaging device 3 and the image processing device 4 are electrically connected through the first connection terminal 211. Specifically, referring to FIG. 9 and FIG. 10, the image processing device 4 and the sensor imaging device 3 are electrically connected to the first connection terminal 211, respectively. The image data obtained by the sensor imaging device 3 is transmitted to the image processor 41 for processing through the first connection terminal 211. Subsequently, the image processor 41 transmits the generated images and/or videos to the first adapter 11 through the first connection terminal 211. Through the first adapter 11, the images and/or videos generated by the image processor 41 are transmitted to the encoder 6 and/or the storage device 7. The transmission path that the sensor imaging device 3 obtains the image data includes: the sensor imaging device 3=>the first connection terminal 211=>the image processor 41=>the first connection terminal 211=>the first adapter 11=>the encoder 6 and/or the storage device 7.

In some embodiments, referring to FIG. 9, the image processor 41 and the first connection terminal 211 are fixedly electrically connected. The image processing device 4 and the first connection terminal 211 are connected in a non-detachable manner. This arrangement can prevent the user from frequently disassembling the image processing device 4 and causing product loss.

In some embodiments, referring to FIG. 10, the image processing device 4 includes a second adapter 42 electrically connected to the image processor 41. The second adapter 42 is electrically connected to the first connection terminal 211. As a result, the image processor 41 is electrically connected to the first connection terminal 211. Moreover, the second adapter 42 and the first connection terminal 211 are detachably connected. When the image processing device 4 needs to be replaced, the second adapter 42 and the first connection terminal 211 are directly separated, thereby achieving rapid replacement of the image processing device 4. Moreover, the second adapter 42 and the first connection terminal 211 are coordinated to achieve multiplexing of a mechanical interface and an electrical interface. The transmission path that the sensor imaging device 3 obtains the image data includes: the sensor imaging device 3=>the first connection terminal 211=>the image processor 41=>the second adapter 42=>the first connection terminal 211=>the first adapter 11=>the encoder 6 and/or the storage device 7.

In some embodiments, the sensor imaging device 3 and the first connection terminal 211 are electrically connected indirectly. Specifically, referring to FIG. 11 and FIG. 12, the sensor imaging device 3 is electrically connected to the first connection terminal 211 through the image processing device 4. In some embodiments, one end of the image processing device 4 is electrically connected to the sensor imaging device 3, and another end of the image processing device 4 is electrically connected to the first connection terminal 211. In some embodiments, the image data obtained by the sensor imaging device 3 is transmitted to the image processor 41. The image processor 41 processes the received image data to generate the images and/or videos. The images and/or videos generated by the image processor 41 are transmitted to the first adapter 11 through the first connection terminal 211. As such, the images and/or videos generated by the image processor 41 are transmitted to the encoder 6 and/or the storage device 7. The transmission path that the sensor imaging device 3 obtains the image data includes: the sensor imaging device 3=>the image processor 41=>the first connection terminal 211=>the first adapter 11=>the encoder 6 and/or the storage device 7.

In some embodiments, referring to FIG. 11, one end of the image processor 41 is fixedly electrically connected to the sensor imaging device 3, and another end of the image processor 41 is fixedly electrically connected to the first connection terminal 211. In some embodiments, the connection between the image processing device 4 and the sensor imaging device 3 and the connection between the image processing device 4 and the first connection terminal 211 are non-detachable. This arrangement can prevent the user from frequently disassembling the image processing device 4 and causing product loss.

In some embodiments, referring to FIG. 12, the image processing device 4 includes the second adapter 42 electrically connected to the image processor 41. The second adapter 42 is electrically connected to the first connection terminal 211, such that the image processor 41 is electrically connected to the first connection terminal 211. Moreover, the second adapter 42 is detachably connected to the first connection terminal 211, such that the image processor 41 and the rotation shaft mechanism 21 are detachably connected. When the image processing device 4 and the sensor imaging device 3 need to be replaced, the second adapter 42 and the first connection terminal 211 are directly detached, thereby achieving rapid replacement of the image processing device 4 and the sensor imaging device 3. Moreover, the second adapter 42 and the first connection terminal 211 are coordinated to achieve multiplexing of the mechanical interface and the electrical interface. The transmission path that the sensor imaging device 3 obtains the image data includes: the sensor imaging device 3=>the second adapter 42=>the first connection terminal 211=>the image processor 41=>the second adapter 42=>the first connection terminal 211=>the first adapter 11=>the encoder 6 and/or the storage device 7.

Further, referring to FIG. 12, the rotation shaft mechanism 21 includes a second connection terminal 212 electrically connected to the sensor imaging device 3. The image processing device 4 also includes a third adapter 43 electrically connected to the image processor 41 and the second connection terminal 212, respectively, such that the image processor 41 is electrically connected to the sensor imaging device 3. The connection between the second connection terminal 212 and the third adapter 43 is detachable, such that the connection between the image processor 41 and the sensor imaging device 3 is detachable. In some embodiments, the image processing device 4 is separated from the sensor imaging device 3 and the first connection terminal 211, respectively, thereby achieving rapid replacement of the image processing device 4. Moreover, the third adapter 43 and the second connection terminal 212 are coordinated to achieve multiplexing of the mechanical interface and the electrical interface. The transmission path that the sensor imaging device 3 obtains the image data includes: the sensor imaging device 3=>the second connection terminal 212=>the third adapter 43=>the image processor 41=>the second adapter 42=>the first connection terminal 211=>the first adapter 11=>the encoder 6 and/or the storage device 7.

In addition, the connection between the image processing device 4 and the rotation shaft mechanism 21 and the connection between the first connection terminal 211 and the first adapter 11 are detachable, such that the detachable connection between the rotation shaft mechanism 21 and the apparatus body 1 is replaced by: a fixed connection between the first connection terminal 211 and the first adapter 11, such that the connection between the rotation shaft mechanism 21 and the apparatus body 1 is fixed. In some embodiments, the rotation shaft mechanism 21 and other structures disposed at the apparatus body 1 may be multiplexed. Although the rotation shaft mechanism 21 and the apparatus body 1 are not separable, the image processing device 4 and/or the sensor imaging device 3 disposed at the rotation shaft mechanism 21 are replaceable, thereby satisfying the user's need.

Referring back to FIG. 9 through FIG. 12, the encoder 6 and/or the storage device 7 are electrically connected to the first adapter 11, such that the image processor 41 is electrically connected to the encoder 6 and/or the storage device 7. The images and/or videos generated by the image processor 41 are transmitted to the first adapter 11 through the first connection terminal 211, and through the first adapter 11, the images and/or videos generated by the image processor 41 are further transmitted to the encoder 6 and/or the storage device 7.

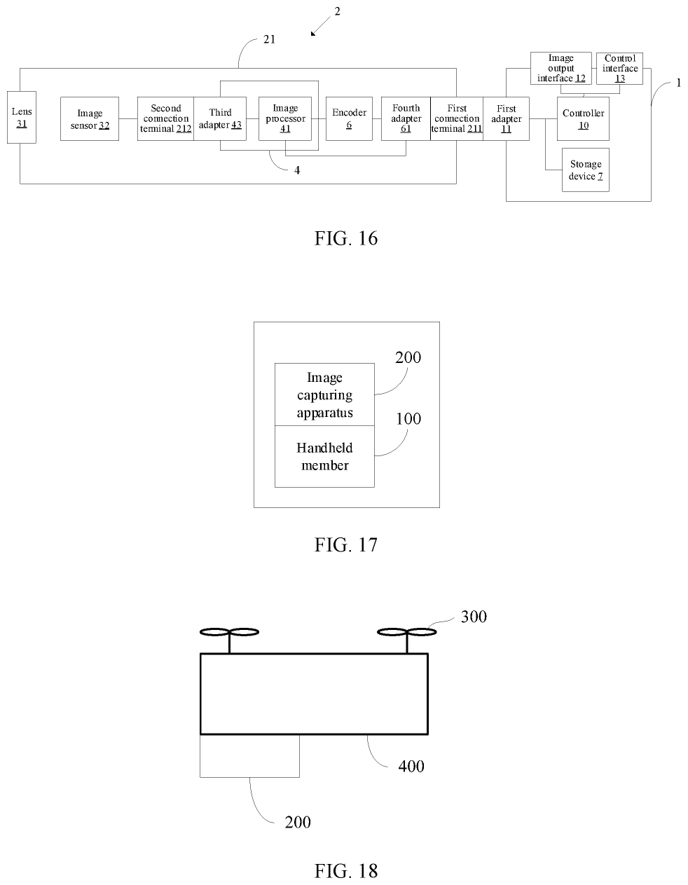

In some embodiments, referring to FIG. 13 and FIG. 16, the sensor imaging device 3, the image processing device 4, and the encoder 6 are disposed at the rotation shaft mechanism 21. The storage device 7 is disposed at the apparatus body 1. Compared with the existing technology, in which the sensor imaging device 3, the image processing device 4, the encoder 6, and the storage device 7 are disposed at the apparatus body 1, and the gimbal 2 drives the apparatus body 1 to rotate, the arrangement of the embodiment in which the sensor imaging device 3, the image processing device 4, and the encoder 6 are disposed at the rotation shaft mechanism 21, and the storage device 7 is disposed at the apparatus body 1, reduces the volume and weight of the load to the rotation shaft mechanism 21. Moreover, the multiplexing of the storage device 7 disposed at the apparatus body 1 and other structures reduces the economic cost, simplifies the product structure, and improves the product aesthetic appearance.

In some embodiments, the image processing device 4 is electrically connected to the encoder 6 and the first connection terminal 211, respectively, the encoder 6 is electrically connected to the first connection terminal 211, and the storage device 7 is electrically connected to the first adapter 11. The first connection terminal 211 is electrically connected to the first adapter 11, such that the electrical connection between the sensor imaging device 3 and the image processing device 4 is replaced by: the electrical connection between the first connection terminal 211 and the first adapter 11, such that the storage device 7 is electrically connected to the image processor 41 or the encoder 6.

The image processor 41 and/or the encoder 6 may be disposed inside the rotation shaft mechanism 21 or on the rotation shaft mechanism 21, which can be selected as needed.

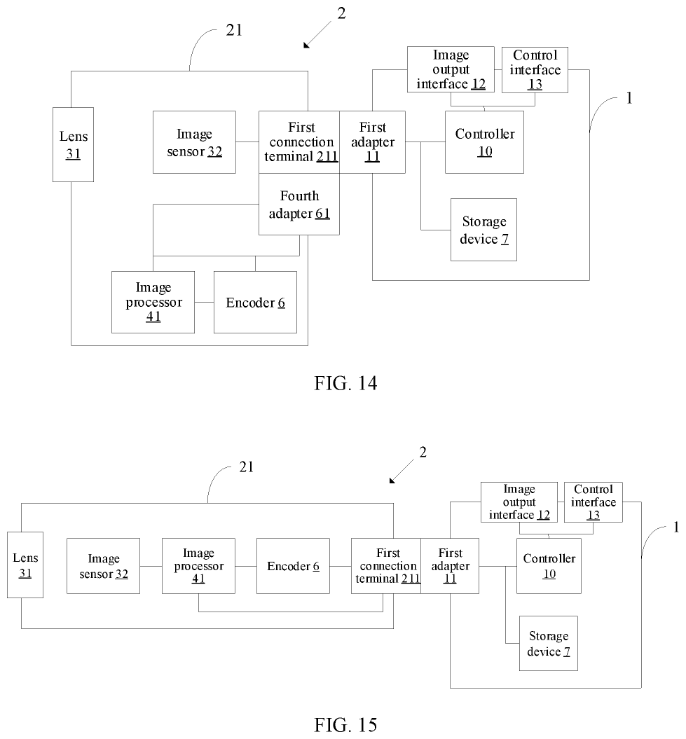

In some embodiments, the sensor imaging device 3 and the first connection terminal 211 may be electrically connected directly or indirectly. For example, the sensor imaging device 3 is electrically connected to the first connection terminal 211 directly. Specifically, referring to FIG. 13 and FIG. 14, the image processing device 4 and the sensor imaging device 3 are electrically connected through the first connection terminal 211. In some embodiments, the image data obtained by the sensor imaging device 3 is transmitted to the image processor 41 for processing through the first connection terminal 211. The image processor 41 generates the images and/or videos and transmits the generated images and/or videos to the first adapter 11 through the first connection terminal 211. The first adapter 11 transmits the images and/or videos generated by the image processor 41 to the storage device 7 and/or the encoder 6. After the images and/or videos generated by the image processor 41 is transmitted to the encoder 6, the encoder 6 compresses the images and/or videos generated by the image processor 41 and transmits the compressed images and/or videos to the first adapter 11 through the first connection terminal 211. Then, the first adapter 11 transmits the compressed images and/or videos to the storage device 7. The transmission path that the sensor imaging device 3 obtains the image data includes: the sensor imaging device 3=>the first connection terminal 211=>the image processor 41=>the encoder 6=>the first connection terminal 211=>the first adapter 11=>the storage device 7, and/or the sensor imaging device 3=>the first connection terminal 211=>the image processor 41=>the first connection terminal 211=>the first adapter 11=>the storage device 7.

In some embodiments, referring to FIG. 13, the image processor 41 is fixedly electrically connected to the first connection terminal 211. In another embodiment, the image processor 41 is fixedly electrically connected to the first connection terminal 211 through the encoder 6. The connection between the image processing device 4 and the first connection terminal 211 is non-detachable. This arrangement can prevent the user from frequently disassembling the image processing device 4 and the encoder 6 and causing product loss.

In some embodiments, referring to FIG. 14, the encoder 6 includes a fourth adapter 61 electrically connected to the first connection terminal 211. The connection between the fourth adapter 61 and the first connection terminal 211 is detachable, such that the image processor 41 and the encoder 6 are detachably connected to the rotation shaft mechanism 21. When the image processor 41 and the encoder 6 need to be replaced, the fourth adapter 61 and first connection terminal 211 are directly separated, thereby achieving rapid replacement of the image processing device 4 and the encoder 6. Moreover, the fourth adapter 62 and the first connection terminal 211 are coordinated to achieve multiplexing of the mechanical interface and the electrical interface. In some embodiments, the transmission path that the sensor imaging device 3 obtains the image data includes: the sensor imaging device 3=>the first connection terminal 211=>the image processor 41=>the encoder 6=>the fourth adapter 61=>the first connection terminal 211=>the first adapter 11=>the storage device 7.

In addition, in some embodiments, the image processor 41 is also electrically connected to the fourth adapter 61, such that the image processor 41 is electrically connected to the storage device 7 directly. The transmission path that the sensor imaging device 3 obtains the image data includes: the sensor imaging device 3=>the first connection terminal 211=>the image processor 41=>the fourth adapter 61=>the first connection terminal 211=>the first adapter 11=>the storage device 7.

In some embodiments, the sensor imaging device 3 is electrically connected to the first connection terminal 211 indirectly. The sensor imaging device 3 is electrically connected to the first connection terminal 211 through the image processing device 4 or through the image processing device 4 and the encoder 6 sequentially. Accordingly, the transmission path that the sensor imaging device 3 obtains the image data includes: the sensor imaging device 3=>the image processor 41=>the encoder 6=>the first connection terminal 211=>the first adapter 11=>the storage device 7, and/or the sensor imaging device 3=>the image processor 41=>the first connection terminal 211=>the first adapter 11=>the storage device 7.

In some embodiments, referring to FIG. 15, one end of the image processor 41 is fixedly electrically connected to the sensor imaging device 3, another end of the image processor 41 is fixedly electrically connected to the first connection terminal 211 and/or the encoder 6, and the encoder 6 is fixed connected to the first connection terminal 211. In some embodiments, the connection between the image processing device 4 and the sensor imaging device 3, the connection between the encoder 6 and the sensor imaging device 3, the connection between the image processing device 4 and the first connection terminal 211, and the connection between the encoder 6 and the first connection terminal 211 are non-detachable. This arrangement can prevent the user from frequently removing the image processing device 4 and the encoder 6 that causes product loss.

In some embodiment, referring to FIG. 16, the encoder 6 includes the fourth adapter 61 electrically connected to the first connection terminal 211. The connection between the fourth adapter 61 and the first connection terminal 211 is detachable, such that the image processor 41 and the encoder 6 are detachably connected to the rotation shaft mechanism 21. When the image processing device 4 and the encoder 6 need to be replaced or the image processing device 4, the encoder 6, and the sensor imaging device 3 need to be replaced, the fourth adapter 61 and first connection terminal 211 are directly separated, thereby achieving rapid replacement of the image processing device 4 and the encoder 6 or the image processing device 4, the encoder 6, and the sensor imaging device 3. Moreover, the fourth adapter 62 and the first connection terminal 211 are coordinated to achieve multiplexing of the mechanical interface and the electrical interface. The transmission path that the sensor imaging device 3 obtains the image data includes: the sensor imaging device 3=>the image processor 41=>the encoder 6=>the fourth adapter 61=>the first connection terminal 211=>the first adapter 11=>the storage device 7, and/or the sensor imaging device 3=>the image processor 41=>the fourth adapter 61=>the first connection terminal 211=>the first adapter 11=>the storage device 7.

Further, referring to FIG. 16, the rotation shaft mechanism 21 includes the second connection terminal 212 electrically connected to the sensor imaging device 3. The image processing device 4 also includes the third adapter 43 electrically connected to the image processor 41. The third adapter 43 and the second connection terminal 212 are electrically connected. The connection between the third adapter 43 and the second connection terminal 212 is detachable, such that the connection between the image processor 41 and the sensor imaging device and the connection between the encoder 6 and the sensor imaging device 3 are detachable. In some embodiments, the image processing device 4 and the encoder 6 are separated from the sensor imaging device 3 and the first connection terminal 211, respectively, thereby achieving rapid replacement of the image processing device 4 and the encoder 6. Moreover, the third adapter 43 and the second connection terminal 212 are coordinated to achieve multiplexing of the mechanical interface and the electrical interface. The transmission path that the sensor imaging device 3 obtains the image data includes: the sensor imaging device 3=>the second connection terminal 212=>the third adapter 43=>the image processor 41=>the encoder 6=>the fourth adapter 61=>the first connection terminal 211=>the first adapter 11=>the storage device 7, and/or the sensor imaging device 3=>the second connection terminal 212=>the third adapter 43=>the image processor 41=>the fourth adapter 61=>the first connection terminal 211=>the first adapter 11=>the storage device 7.

In addition, after the image processing device 4 and the encoder 6 are detachably connected to the rotation shaft mechanism 21, the first connection terminal 211 is detachably connected to the first adapter 11, such that the detachable connection between the rotation shaft mechanism 21 and the apparatus body 1 is replaced by: the fixed connection between the first connection terminal 211 and the first adapter 11, such that the rotation shaft mechanism 21 is fixedly connected to the apparatus body 1. In some embodiments, the rotation shaft mechanism 21 and other structures disposed at the apparatus body 1 are multiplexed. Although the rotation shaft mechanism 21 and the apparatus body 1 are not separable, the image processing device 4 and the encoder 6, and/or the sensor imaging device 3 disposed at the rotation shaft mechanism 21 are replaceable, thereby satisfying the user's need.

Referring back to FIG. 13 through FIG. 16, the storage device 7 is electrically connected to the first adapter 11, such that the image processor 41 and/or the encoder 6 are electrically connected to the storage device 7. After the images and/or videos generated by the image processor 41 are compressed by the encoder 6, the compressed images and/or videos are transmitted to the first adapter 11 through the first connection terminal 211. Then, the first adapter 11 transmits the compressed images and/or videos to the storage device 7. In some embodiments, the images and/or videos generated by the image processor 41 is transmitted to the first adapter 11 directly through the first connection terminal 211. Then, the first adapter 11 transmits the images and/or videos generated by the image processor 41 to the storage device 7.

In the embodiments of the present disclosure, referring to FIG. 9 through FIG. 12, the image capturing apparatus further includes a controller 10 disposed at the apparatus body 1 (disposed inside the apparatus body 1 or on the apparatus body 1). The controller 10 is electrically connected to the first adapter 11, such that the controller 10 is electrically connected to the image processor 41. Moreover, the controller 10 is also electrically connected to the image output interface 12. After passing through the first connection terminal 211 and the first adapter 11, the images and/or videos generated by the image processor 41 are inputted to the controller 10. The transmits the received images and/or videos to the backend device through the image output interface 12. Further, the controller 10 is also electrically connected to the control interface 13 to achieve a communication connection between the external control device and the controller 10. The communication between the external control device and the controller 10 may control the operation of the image capturing apparatus. The specific implementation principle is similar to the implementation principle of the communication connection between the external control device and the image processor 41 described in the previous embodiments, and will not be repeated herein. In the embodiments of the present disclosure, the image output interface 12 and the control interface 13 are disposed at the apparatus body 1.

It should be noted that the image capturing apparatus consistent with the embodiments of the present disclosure may be applied to a handheld gimbal or a movable platform. For illustration purpose, the applications of the image capturing apparatus in the handheld gimbal and the movable platform are described in detail below.

Referring to FIG. 17, the present disclosure also provides a handheld gimbal. The handheld gimbal includes a handheld member 100 and an image capturing apparatus 200 coupled with the handheld member 100. The structures, functions, operation principles, and effects of the image capturing apparatus may be referred to the description of the embodiments of the image capturing apparatus, and will not be repeated herein.

The apparatus body 1 of the image capturing apparatus 200 is connected to the handheld member 100. The connection between the apparatus body 1 and the handheld member 100 may use any existing connection methods, such as snap connection, screw thread connection, and quick release connection, etc. The handheld member 100 may be a handheld stick or another handheld structure. The structure of the handheld member 100 is not limited by the present disclosure.

In professional filming scenes, such as filming movies and television shows, the gimbal 2 is currently a two-axis gimbal connected to the apparatus body 1. When the current gimbal 2 needs to be replaced by a three-axis gimbal, the first connection terminal 211 can be detached from the first adapter 11 to replace the rotation shaft mechanism 21 of the current two-axis gimbal with the rotation shaft mechanism of the three-axis gimbal. As such, the sensor imaging device 3 and the rotation shaft mechanism 21 as a whole can be replaced conveniently and quickly.

Referring to FIG. 18, the present disclosure also provides a movable platform. The movable platform includes a driving assembly 300 and an image capturing apparatus 200. The driving assembly 300 is connected to the image capturing apparatus 200 and is used to drive the image capturing apparatus 200 to move, thereby capturing more diverse images and/or videos. The structures, the functions, the operation principles, and the effects of the image capturing apparatus 200 may be referred to the description in the embodiments of the image capturing apparatus, and will not be repeated herein.

The apparatus body 1 of the image capturing apparatus 200 is connected to the driving assembly 300. For example, the driving assembly 300 may include an electric motor. The apparatus body 1 is connected to the electric motor through the rotation shaft mechanism 21, such that the electric motor drives the apparatus body 1 to move. The driving assembly 300 may also include another driving apparatus, such as a screw rod.

In some embodiments, referring to FIG. 18, the movable platform is an unmanned aerial vehicle (UAV). The apparatus body 1 is mounted at a vehicle body 400 of the UAV.

In some embodiments, the movable platform is a ground-based movable vehicle, such as a remotely controlled vehicle, a dolly cart, a crane, and another movable platform that can move smoothly with a certain degree of freedom.

In some embodiments, the movable platform is a movable vehicle movable on a water surface.

It should be understood that, in this specification, relational terms such as first and second are only used to distinguish one entity or operation from another entity or operation, and do not necessarily require or imply existence of the actual relationship or sequence among these entities or operations. The terms “include,” “comprise,” “contain,” or any other variants thereof are intended to cover non-exclusive inclusion, so that a process, a method, an article, or a device including a series of elements not only includes these elements, but also includes other elements not explicitly listed, or further includes elements inherent to the process, the method, the article, or the device. In the absence of further restrictions, the element associated with “including a . . . ” does not exclude the existence of other same elements in the process, the method, the article, or the device that includes the element.

The image capturing apparatus, the handheld gimbal including the image capturing apparatus, and the movable platform provided by the embodiments of the present disclosure are described in detail. In the specification, specific examples are used to explain the principles and implementations of the present disclosure. The description of the embodiments is intended to assist comprehension of the methods and core inventive ideas of the present disclosure. Further, those of ordinary skill in the art may change or modify the specific implementation and the scope of the application according to the ideas of the present disclosure. Thus, the content of the specification should not be construed as limitation to the present disclosure.

What is claimed is:

1. An image capturing apparatus comprising:
an apparatus body including an adapter;
a gimbal including a rotation shaft mechanism detachably connected to the apparatus body, the rotation shaft mechanism including a connection terminal detachably connected to the adapter and electrically connected to the adapter;
a sensor imaging device disposed at the rotation shaft mechanism and electrically connected to the connection terminal; and
an image processing device disposed at the apparatus body and electrically connected to the sensor imaging device via the connection terminal and the adapter.

2. The image capturing apparatus according to claim 1, wherein:
the sensor imaging device includes a lens and an image sensor coupled with the lens, the lens and the image sensor being mounted at the rotation shaft mechanism.

3. The image capturing apparatus according to claim 2, wherein:
a diagonal line of an effective imaging area of the image sensor is greater than or equal to about 25.8 mm.

4. The image capturing apparatus according to claim 2, wherein:
a resolution of the image sensor is no smaller than 4K resolution.

5. The image capturing apparatus according to claim 2, wherein:
at least one of the lens or the image sensor is detachably connected to the rotation shaft mechanism; or
the sensor imaging device includes an enclosure detachably connected to the rotation shaft mechanism, the lens and the image sensor being fixed to the enclosure.

6. The image capturing apparatus according to claim 1, further comprising:
a signal line having a data rate greater than a specified data rate;
wherein the sensor imaging device is electrically connected to the connection terminal through the signal line.

7. The image capturing apparatus according to claim 1, wherein:
the rotation shaft mechanism includes a bracket and an electric motor configured to drive the bracket; and
the connection terminal and the sensor imaging device are disposed at the bracket.

8. The image capturing apparatus according to claim 1, further comprising:
a control circuit configured to control operation of the rotation shaft mechanism, the control circuit being disposed at the apparatus body or at the rotation shaft mechanism, and being electrically connected to the image processing device.

9. The image capturing apparatus according to claim 8, wherein:
the gimbal further includes an inertial measurement unit (IMU) disposed at the rotation shaft mechanism and electrically connected to the control circuit.

10. The image capturing apparatus according to claim 1, wherein:
the image processing device includes an image processor; and
the adapter is electrically connected to the image processor.

11. The image capturing apparatus according to claim 10, wherein:
a format of images and/or videos generated by the image processor includes at least one of RAW, RGB, or YUV.

12. The image capturing apparatus according to claim 10, wherein the apparatus body further includes at least one of:
an image output interface electrically connected to the image processor; or
a control interface electrically connected to the image processor and configured to be connected to an external control device.

13. The image capturing apparatus according to claim 10, further comprising:
an encoder disposed at the apparatus body, the encoder being electrically connected to the image processor and configured to compress images and/or videos generated by the image processor.

14. The image capturing apparatus according to claim 13, wherein:
a coding format that the encoder uses to encode images and/or videos generated by the image processor includes at least one of RAW, Apple ProRes RAW, DNxHR/DNxHD, or JPEG-Lossless.

15. The image capturing apparatus according to claim 13, further comprising:
a storage device electrically connected to at least one of the encoder or the image processor.

16. The image capturing apparatus according to claim 15, wherein:
the storage device is disposed at the apparatus body.

17. The image capturing apparatus according to claim 16, further comprising:
a signal line having a data rate greater than a specified data rate;
wherein the storage device is electrically connected to at least one of the encoder or the image processor through the signal line.

18. The image capturing apparatus according to claim 17, wherein:
the apparatus body further includes a storage interface electrically connected to at least one of the encoder or the image processor through the signal line; and
the storage device is electrically connected to the storage interface.

19. A movable platform comprising:
an image capturing apparatus including:
an apparatus body including an adapter;
a gimbal including a rotation shaft mechanism detachably connected to the apparatus body, the rotation shaft mechanism including a connection terminal detachably connected to the adapter and electrically connected to the adapter;
a sensor imaging device disposed at the rotation shaft mechanism and electrically connected to the connection terminal; and
an image processing device disposed at the apparatus body and electrically connected to the sensor imaging device; and
a driving assembly connected to the image capturing apparatus and configured to drive the image capturing apparatus to move.

20. The movable platform according to claim 19, wherein:
the movable platform includes an unmanned aerial vehicle (UAV), a ground-based movable vehicle, or a movable vehicle movable on a water surface.
